(19) United States
(12) Patent Application Publication
(10) Pub. No.: US 2004/0259538 A1
(43) Pub. Date: Dec. 23, 2004

(54) Wireless multipurpose communication system

(76) Inventor: Victor Agbegnenou, Asnieres S/Siene (FR)

Correspondence Address: NIXON & VANDERHYE, PC, 1100 N GLEBE ROAD, 8TH FLOOR, ARLINGTON, VA, 22201-4714, US

(21) Appl. No.: 10/492,361

(22) PCT Filed: Oct. 11, 2002
(86) PCT No.: PCT/FR02/03458

(51) Int. Cl. H04M 1/00

(52) U.S. Cl. 455/422.1; 455/550.1

(57) ABSTRACT

The system comprises a multiple outlet terminal (100), individual connection modules (200), and independent out-stations (300). The terminal (100) is connected to a plurality of telecommunications lines (102) and comprises line interface means, a plurality of individual outlets (104), and distributor means. Each module (200) can be separably mounted on any one of the outlets and comprises means for interfacing with the distributor means of the terminal, wireless transceiver means, and control means suitable for converting the signals coming from a line and delivered by the terminal into radio signals, and for converting received radio signals into signals for delivering to the same line. Each out-station (300) comprises wireless transceiver means suitable for establishing a both-way communications channel, and means for interfacing with transducers (310, 312, 314) for picking up and/or playing back audio, video, and/or digital data signals.

The invention relates to a versatile communications system making use of wireless technologies.

It is known that wireless technologies are flexible in use, and more particularly that short range wireless or cordless technologies are flexible in use, for example enabling wireless links to be managed between telephone sets and base stations connected to the wired telephone network.

However, these technologies are implemented only at the subscriber's installation using outlets located in the subscriber's apartment or house and connected to line-grouping units common to a plurality of users, in turn connected to a central exchange of the network.

Terminal wiring in buildings or in residential areas is always expensive to install, being associated with imperatives concerning costs, time for installation, and lack of flexibility, since in practice installing a subscriber line all the way to the subscriber's home can be justified only for durable use, implying a subscription of fairly long term and charges for connection to the network in order to defray the various expenses involved in establishing a line all the way to the subscriber's home.

These practical constraints and the corresponding costs have slowed down telephone development in certain countries, in particular in developing countries, where the resources of potential users are limited and where the complex structure of the environment makes it very difficult to lay lines. All of those constraints lead to obstacles to individual telephones becoming widespread to the advantage of the greatest number.

In addition, because of their lack of flexibility, wired telecommunications networks are not suitable for situations where a subscriber desires to have a line for a limited duration only (e.g. for a few hours or a few days only), or where the user is going to travel between several different locations. The use of a radiotelephone of the GSM type, for example, does indeed constitute a solution that is appropriate for such situations, however it involves means that are relatively expensive and that, in addition, require the user to be located in a zone that is covered by the radiotelephone network, and that is far from being the case in numerous isolated regions in countries that are very large and in which only urban areas are covered by the network.

One of the objects of the invention is to mitigate those various limitations of wire networks by proposing a communications system that enables a subscriber to be connected to the telephone network simply and quickly (and thus at low cost), and that in addition is very flexible.

As explained below, the system of the invention serves not only to provide a telephone connection, but also to implement numerous other applications such as: local interphones, voice and data servers (e.g. transmitting music delivered by a Walkman), image servers in professional applications such as medical imaging, multimedia games servers, etc.

To this end, the invention provides a system comprising, in combination:

a multiple outlet terminal connected to a plurality of telecommunications lines and comprising means for interfacing with said plurality of lines, a plurality of individual outlets, and distributor means suitable for selectively coupling said plurality of outlets to said plurality of lines;

at least one individual connection module suitable for being separably mounted on one of said outlets, and comprising interface means for interfacing with said distributor means of the terminal, wireless transceiver means, and control means for controlling the interface means and the transceiver means, being suitable for converting signals delivered by the distributor means of the terminal and coming from a line into radio signals for transmission, and for converting received radio signals into signals that are delivered to the distributor means of the terminal for application to the same line; and

for each individual connection module, at least one independent out-station comprising wireless transceiver means suitable for establishing a both-way call with an individual connection module associated with said out-station, and interface means for interfacing with transducers for picking up and/or playing back audio, video, and/or digital data signals.

When the number of lines is smaller than the number of outlets, the terminal includes multiplexer means suitable for selecting the module allocated to a given user in the event of an incoming call on a line for that user, or conversely for selecting an available line for a call coming from a user.

According to various advantageous subsidiary characteristics:

the terminal further comprises relay transceiver means co-operating with the transceiver means of the modules so as to receive the radio signals transmitted by said modules and retransmit them, after amplification, to the out-stations;

the interface means of the terminal include means for interfacing with one or more networks of the PSTN, VSAT, ADSL, radio station, local wire loop, or radiotelephone network type; and

the terminal further comprises electrical power supply means, and the outlets include terminals for electrically powering individual modules and/or recharging individual power supplies belonging to the individual modules.

In a first embodiment, each out-station is allocated statically in one-to-one correspondence to a given module.

In a second embodiment, the number of out-stations is greater than the number of modules, with each out-station being allocated in dynamic and variable manner to a given module. The modules may then include means for receiving a request for a connection transmitted by an out-station, for sending to the terminal control means a request for access authorization and for line allocation, for receiving from the terminal a signal authorizing access and connection to a network line, together with a radio channel identifier, and for establishing a call with said-out-station over the channel as identified in this way.

Furthermore, and in addition, the modules may advantageously include means for coupling to audio, video, and/or digital data signal sources, and means forming a local server suitable for controlling independently the exchange of signals between said sources and the transceiver means to and/or from the out-station associated with the module.

An embodiment is of the invention is described below with reference to the accompanying drawings.

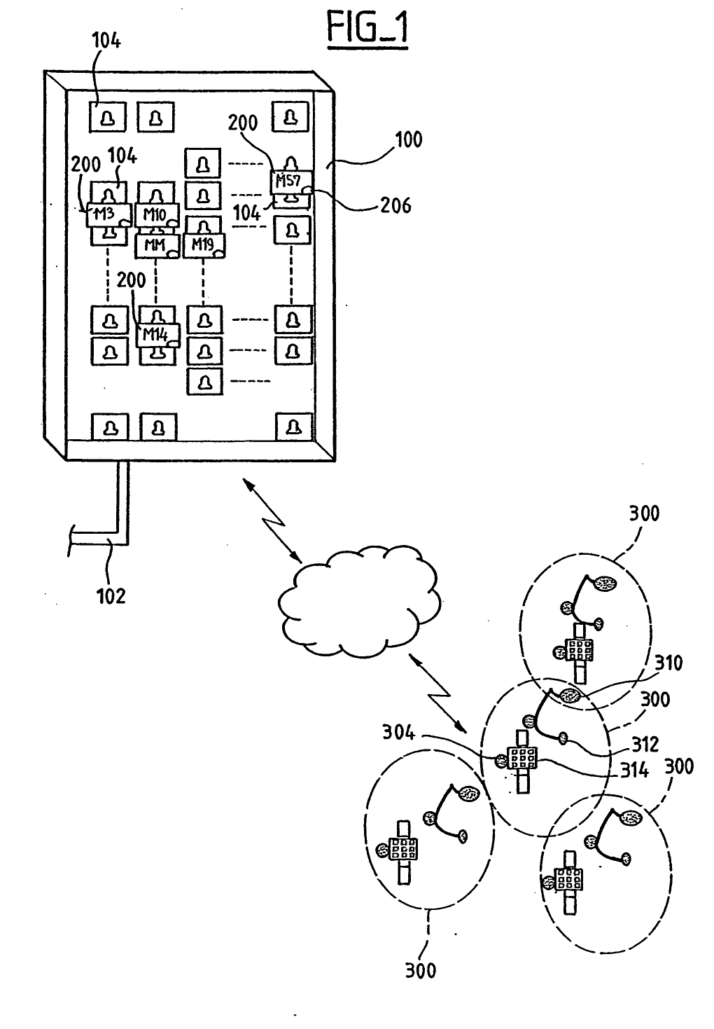

FIG. 1 is a diagrammatic view showing the various elements constituting the system of the invention.

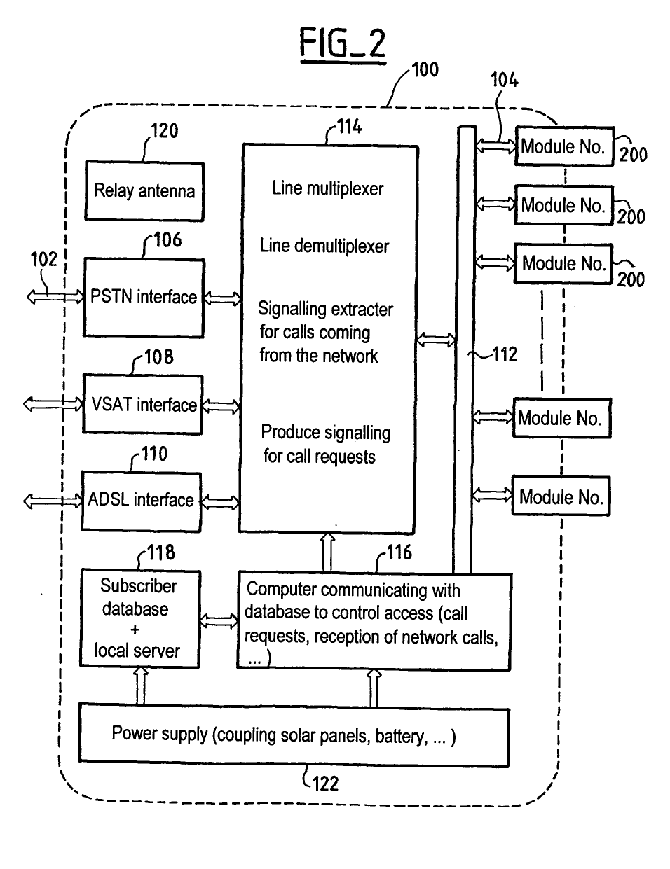

FIG. 2 is a block diagram of the multi-outlet terminal of the system of the invention.

FIG. 3 is a block diagram of the individual connection module of the system of the invention.

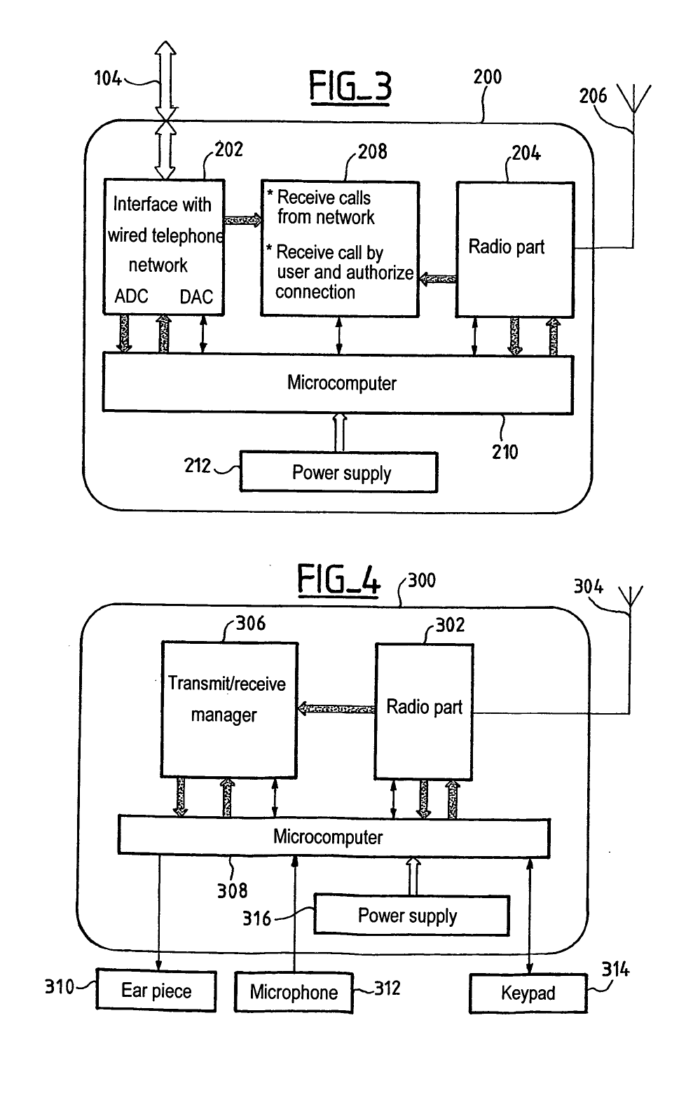

FIG. 4 is a block diagram of the out-station of the communications system of the invention.

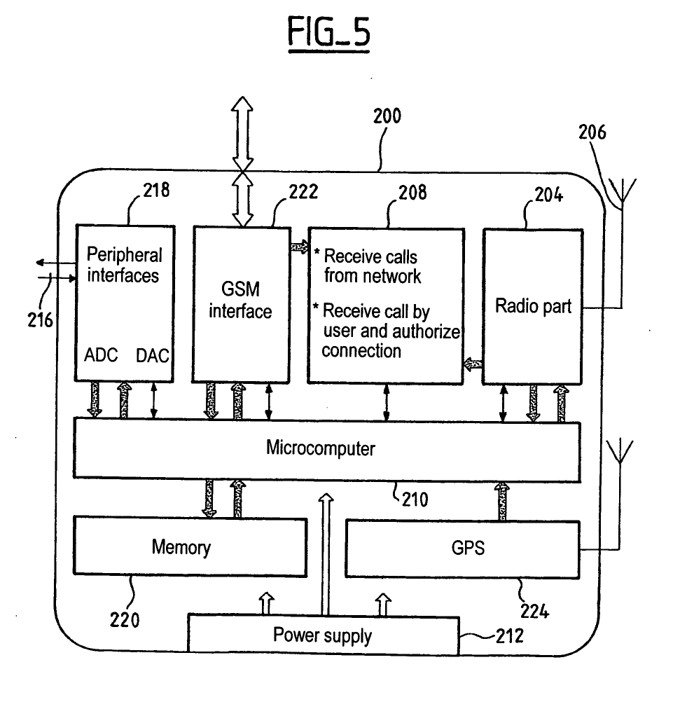

FIG. 5 shows an improved variant of the individual connection module of FIG. 3, configured to be capable of operating as a local server.

As shown in FIG. 1, the system of the invention comprises a multiple-outlet terminal 100 (referred to below as the “terminal”) comprising a cabinet connected to a bundle of telecommunications lines 102 (referred to below as “lines”), which may be conventional lines of the public switched telephone network (PSTN), or indeed a satellite bundle of the VSAT type, or optical fiber lines, or even lines of a non-wired network (a radiotelephone network).

The terminal carries a series of individual outlets 104 (referred to below as “outlets”) each suitable for receiving an individual connection module 200 (referred to below as a “module”) merely by being plugged therein. Each module 200 is personalized and allocated to a user, e.g. a given house or an apartment in a building or a residential area.

There may be provided as many outlets 104 are there are lines 102; given that all of the outlets are not necessarily used simultaneously, it is possible to provide a number of outlets 104 that is greater than the number of lines 102, making use of multiplexing technology of conventional kind enabling the number of outlets to be increased.

Each of the modules 200 communicates with wireless transceiver means or with one or more out-stations or “kits” 300 made available to the various users. Each kit 300 comprises the various members needed for making a telephone call, specifically, at least: an earpiece 310; a microphone 312; and a keypad 314 which are in both-way wireless communication (antenna 304) with a module 200 (antenna 206) with which the kit is associated.

As shown, the earpiece and microphone set may be a system that does not have any wire connecting it to the keypad or the central housing of the kit, but the kit may equally well present the external appearance of a conventional telephone set that is cordless or that has a handset connected by a cord to a housing provided with a keypad.

With this general configuration, there is no need to wire telephone lines within apartments or houses; the terminal 200 can be communal, residential, private, or public, depending on the location and the use for which it is intended.

The outlets and the modules may be installed on a panel accessible only to an operator of the telecommunications service.

In a variant, the outlets may be made directly accessible to users who install their own modules on a temporary basis for the time required to make a call or for a few hours only, for example. In this configuration, the user module may be connected by the user to any outlet of any terminal, thus enabling the user to make a call from the user's own kit in any location, and using the same equipment at home, at work, or from a public terminal installed in the street.

The various elements of the communication system are described in detail below with reference to FIGS. 2 to 5.

FIG. 2 is a block diagram showing the various functional members constituting a terminal 100.

For connection to the lines 102, there are provided interfaces 106, 108, 110, . . . , specific to each type of connection (PSTN, VSAT, ADSL, etc.) and including the various communications protocols needed for exchanging information.

In addition, connection with the various modules 200 plugged into the outlets 104 is provided via a bus 112.

The interfaces 106, 108, 110, and the bus 112 are connected to a central management unit 114 performing the various necessary functions such as:

multiplexing/demultiplexing the lines;

extracting signaling for incoming calls arriving on the various lines; and

generating signaling for call requests coming from the various kits via the modules 200.

This management unit is controlled by a computer 116 suitable for co-operating with a local database 118 storing information in memory relating to the various subscribers for which a module 200 has been plugged into an outlet of the terminal, specifically for the purpose of managing line access control, and various functions such as signaling specific to the subscriber, managing call billing, etc.

The terminal 100 may optionally have a memory enabling it to act as a local Internet server, the various modules being suitable for delivering server content on devices associated with respective out-stations.

The terminal may have a relay antenna 120 enabling the transmission range between modules and kits to be increased, forwarding data from the antenna of a module installed on the terminal to a remote kit, and vice versa.

Finally, the terminal includes its own power supply system (solar cells, battery, etc.), which is advantageously also used for powering the various modules 200 in addition to their own individual power supplies; plugging a module into an outlet thus also serves to couple it with an electrical power supply.

The general architecture of an individual connection module is shown diagrammatically in FIG. 3.

Each module 200 mounted on an outlet 104 of the terminal has an interface 202 with the terminal, radiotransceiver means 204 co-operating with an antenna 206, and a central management unit 208 controlled by a microcomputer 210. As mentioned above, the power supply 212 may advantageously be delivered by the terminal.

The out-station 300 is shown diagrammatically in FIG. 4. It comprises a radiotransceiver part 302 connected to an antenna 304, with a managing central unit 306 controlled by a microcomputer 308.

Various transducers such as an earpiece 310, a microphone 312, and a keypad 314 are connected to the microcomputer 308 over wire connections, or advantageously over wireless connections using technologies such as Bluetooth, DECT, etc. The station also has a power supply 316, e.g. a rechargeable battery.

The out-station 300 may advantageously be a hands-free kit, where the earpiece 310, the microphone 312, and the keypad 314 are physically independent elements, each having its own transceiver means for communication with the individual connection module 200. Advantageously, the earpiece is then implemented in the form of a headset and that can have plugged into it in plug-and-play mode (i.e. live, without reinitializing the equipment): i) a second earpiece having no radio means (a mere transducer for improving listening comfort); and/or ii) the microphone 312, in a housing situated on an extension of the headset, extending close to the mouth of the user. The keypad can be integrated in an object in the form of a pen, a watch, etc. In addition, provision can most advantageously be made in said object for a socket into which the microphone 312 can be plugged in plug-and-play mode. The user can thus place the microphone either on the headset, or on the object carrying the keypad (e.g. a pen engaged in a breast pocket); it should be observed that under such circumstances, the microphone does not need to be functionally independent, and can be merely a transducer using the transceiver means of the earpiece 310 or of the keypad 314, as appropriate.

In general, the kit includes the user's identification number, which may be incorporated in a memory of the microcomputer, or else written in a separable smart card of the same type as the SIM cards of GSM radiotelephones, or indeed in the form of a code keyed-in by the user when making a connection.

In a first embodiment, a physical channel (frequency, code, . . . ) is allocated statically to each module 200 and thus to each kit 300 associated therewith. This makes it possible to have modules that are relatively simple, with the central management unit 208 serving essentially to detect incoming or outgoing calls and to transfer information between the interface 202 and the radio part 204.

Nevertheless, this solution presents the drawback of requiring as many modules as there are telephone line subscriptions, even though the probability of all of the users making calls simultaneously is practically nil.

Thus, in a second embodiment, it is possible to optimize the terminal by reducing the number of modules compared with the number of potential users. Channels are then allocated in dynamic and variable manner, with modules not being allocated in fixed manner to any one given user.

To this end, the central management unit 208 thus performs various additional functions, the sequence being as follows on a user making a connection request:

the calling kit sends a general connection request over a reserved radio channel, which request includes the user's identification number;

this request is received by all of the inactive modules on the terminal (i.e. modules which are not engaged in a call);

the module(s) receiving the call forward(s) the call to the central management unit 114 of the terminal;

the terminal checks in its database that the identification number is to be found in a list of authorized users, and it sends to one of the modules authorization to connect the user to the telephone network; this authorization is accompanied by a parameter giving the number of the radio channel that is to be used; and

the module as selected in this way sends to the kit in question over the reserved channel information concerning the authorization together with a channel number (or else it sends a signal refusing to set up a call).

The function of checking the user's identification number can be extended over a plurality of terminals of the same type, with all of the users accepted for accessing the terminals to make calls being shared between the terminals; thus, a user can make use equally well of any one terminal amongst several, depending on the user's instantaneous geographical position, thereby enabling the coverage area to be extended.

The modules may optionally manage call transfer functions, with the user then having two modules, one of which (the “stationary module”) is connected to an outlet for the user's usual telephone number; the user then programming the memory of said stationary module, either directly or remotely, with numbers to which the user seeks to redirect calls. The user carries a second module (“mobile module”), so as to be able to plug it into any other outlet away from home. If an absent user receives a call on that user's usual number, then the stationary module undertakes a search on the national or international network to see if the mobile module is connected to another outlet. If so, the call is transferred to the terminal where the mobile module is connected so that the kit rings and the user receives the call wherever the user happens to be. Advantageously, when the mobile module is not connected anywhere, the stationary module redirects the call to a radiotelephone number. This roaming principle is made possible by the fact that each module has an identification code, e.g. written in the memory of a smart card of the same type as SIM cards in GSM radiotelephones. This is the code that is searched for during a roaming operation, whether on the national network or on the international network.

Once the mobile module is connected to the network, it too can be programmed automatically to make a direct connection to the stationary module, so as to simplify and facilitate the roaming procedure.

In addition to the above-described telephony functions, the modules 200 may each be used in independent manner as a versatile adapter acting as a local server of audio, video, or other data.

The architecture of the module 200 is then as shown in FIG. 5.

In addition to the elements described above, the module includes one or more interfaces 218 making it possible via outlets 216 to establish connections to various appliances such as a Walkman, a video camera, a medical probe (ophthalmoscope, auriscope, stethoscope, echographic or Doppler probe, ECG pickup), etc.

These various appliances issue digital or digitized signals that are transmitted by the radio part 204 of the module 200 to a remote kit 300, e.g. the earpiece of the kit for an audio source, a video screen of the kit to reproduce images, etc. In the example of a Walkman being connected to the module, the module broadcasts audio signals from the Walkman to the remote kit. In this way, a Walkman with initially-wired earpieces is transformed into a wireless Walkman by means of the module and the remote kit. The kit may advantageously include wireless functions for controlling the signal or data source, enabling the user to have full control over the transmission and broadcasting of such signals from the kit.

The module 200 may also include members such as a mass memory 220, a GSM interface 222, a GPS positioning circuit 224, etc., in order to implement various functions such as geographical positioning or downloading data.

If the user simultaneously connects a Walkman and a GSM radiotelephone to the module, then the user can listen to music from the connected Walkman and receive a telephone call over the GSM telephone; in the event of a call arriving or being initiated, the module gives priority by default to the telephone call. It thus acts as an audio and data signal server with priority being given to a GSM call over other functions. This priority may naturally be modified by programming the module suitably. This extension is also valid for any other source of audio and/or data signals.

This module architecture can also provide other local functions such as interphone functions between a plurality of users each having a kit connected to a channel of the module, or indeed as a recorder of audio or data signals coming from the kit (“Dictaphone” functions) or conversely, as a recorder of voice or digital messages left by callers in the absence of a response by the user (“answering machine” function).

Finally, it is emphasized that the modules may advantageously be connected not only to the outlets of terminals of the kind described above, but also to any other telephone outlet, for example a wall outlet, by means of a suitable adapter.

1. A versatile wireless communications system, characterized in that it comprises in combination:
a multiple outlet terminal (100) connected to a plurality of telecommunications lines (102) and comprising:
means (106, 108, 110) for interfacing with said plurality of lines;
a plurality of individual outlets (104); and
distributor means (114, 116) suitable for selectively coupling said plurality of outlets to said plurality of lines;
at least one individual connection module (200) suitable for being separably mounted on one of said outlets, and comprising:
interface means (202) for interfacing with said distributor means of the terminal;
wireless transceiver means (204, 206); and
control means (208, 210) for controlling the interface means and the transceiver means, being suitable for converting signals delivered by the distributor means of the terminal and coming from a line into radio signals for transmission, and for converting received radio signals into signals that are delivered to the distributor means of the terminal for application to the same line; and
for each individual connection module, at least one independent out-station (300) comprising:
wireless transceiver means (302, 304) suitable for establishing a both-way call with an individual connection module associated with said out-station; and
interface means (306, 308) for interfacing with transducers (310, 312, 314) for picking up and/or playing back audio, video, and/or digital data signals.

2. The system of claim 1, in which the number of lines is smaller than the number of outlets, the terminal including multiplexer means suitable for selecting the module that is allocated to a given user in the event of an incoming call on a line destined for that user, or vice versa for selecting an available line in the event of a call coming from a user.

3. The system of claim 1, in which the terminal further comprises relay transceiver means (120) co-operating with the transceiver means of the modules so as to receive the radio signals transmitted by said modules and retransmit them, after amplification, to the out-stations.

4. The system of claim 1, in which the interface means of the terminal include means for interfacing with one or more networks of the PSTN, VSAT, ADSL, radio station, local wire loop, or radiotelephone network type.

5. The system of claim 1, in which the terminal further comprises electrical power supply means (122), and the outlets include terminals for electrically powering individual modules and/or recharging individual power supplies belonging to the individual modules.

6. The system of claim 1, in which each out-station is allocated statically and into one-to-one correspondence with a single given module.

7. The system of claim 1, in which the number of out-stations is greater than the number of modules, with each out-station being allocated to a given module in dynamic and variable manner.

8. The system of claim 7, in which the modules include means for:
receiving a connection request issued by an out-station;
sending to the terminal control means a request for access authorization and line allocation;
receiving from the terminal a signal authorizing access and connection to a network line, together with a radio channel identifier; and
setting up a call with said out-station over the channel as identified in this way.

9. The system of claim 1, in which the modules comprise:
means (216, 218) for coupling to audio, video, and/or digital data signal sources; and
means (210, 220) forming a local server, suitable for controlling in independent manner the exchange of signals between said sources and said transceiver means destined for and/or coming from the out-station associated with the module.

10. The system of claim 1, in which:
the independent out-station (300) comprises an earpiece (310), a microphone (312), and a keypad (314) that are physically independent and that are provided with associated wireless transceiver means;
the earpiece is implemented in the form of a headset to which there may be plugged i) a second earpiece having no transceiver means, and/or ii) said microphone (312); and
the keypad is integrated in a distinct object, to which the said microphone (312) may also be plugged.

11. The system of claim 10, in which the microphone (312) is a transducer lacking its own transceiver means and co-operating with the transceiver means of the element to which it is connected, i.e. the earpiece (310) or the keypad (314), as the case may be.
